(19) United States
(12) Patent Application Publication
(10) Pub. No.: US 2013/0282845 A1
(43) Pub. Date: Oct. 24, 2013

(54) SOLUTION FOR BROADBAND MOBILE OVERAGE CHARGING AND BANDWIDTH ISSUES

(71) Applicant: Thomas J. McWilliams, Bryn Mawr, PA (US)

(72) Inventor: Thomas J. McWilliams, Bryn Mawr, PA (US)

(73) Assignee: 4 LEAF PARTNERS, LLC, Wilmington, DE (US)

(21) Appl. No.: 13/861,821

(22) Filed: Apr. 12, 2013

Related U.S. Application Data
(60) Provisional application No. 61/623,101, filed on Apr. 12, 2012.

(51) Int. Cl. H04L 29/08

(52) U.S. Cl. CPC H04L 67/32
USPC 709/206; 709/217

(57) ABSTRACT

The present invention provides for the chunking of the data, and the delivery of high bandwidth chunks to a requesting user at times that are more convenient for the network.

### CROSS-REFERENCE TO RELATED APPLICATIONS

The application claims priority to U.S. Provisional Application No. 61/623,101, filed Apr. 12, 2012, entitled Solution For Broadband Mobile Overage Charging And Bandwidth Issues, the entirety of which is incorporated by reference herein.

### FIELD OF THE INVENTION

The present invention relates to broadband information servcies and, more particularly, to a solution for broadband mobile overage charging and bandwidth issues.

### BACKGROUND OF THE INVENTION

In current embodiments, broadband mobile pricing typically charges by usage rates, because demand exceeds the supply necessary to cover all broadband requests. Thus, high volume broadband data users are penalized, and asked to pay more for exacerbating the broadband bandwidth problem. However, although the current focus of present broadband managers is to dis-incentivize high volume users, a better approach would be to dis-incentivize high volume users only at times when their data demands would exacerbate a bandwidth problem—that is, high volume use should be dis-incentivized only at busy times.

### SUMMARY OF THE INVENTION

The present invention proposes to incentivize use of high volume users at less busy times across users. In short, the present invention allows for the chunking of the data, and the delivery of high bandwidth chunks to a requesting user at times that are more convenient for the network.

### BRIEF DESCRIPTION OF THE DRAWINGS

The accompanying drawings are included to provide a further understanding of the disclosed embodiments. In the drawings:

FIG. 1 is a block diagram of an exemplary computing system for use in accordance with herein described systems and methods;

FIG. 2 is a block diagram showing an exemplary networked computing environment for use in accordance with herein described systems and methods;

FIG. 3 is an illustration showing an exemplary communication environment in accordance with the herein described systems and methods.

### DETAILED DESCRIPTION

A computer-implemented platform and methods of use are disclosed that provide networked access to a plurality of types of digital content, including but not limited to video, audio, and document content, and that track and deliver the accessed content, such as via one or more applications, or “apps.” Described embodiments are intended to be exemplary and not limiting. As such, it is contemplated that the herein described systems and methods can be adapted to provide many types of users with access and delivery of many types of domain data, and can be extended to provide enhancements and/or additions to the exemplary services described. The invention is intended to include all such extensions. Reference will now be made in detail to various exemplary and illustrative embodiments of the present invention.

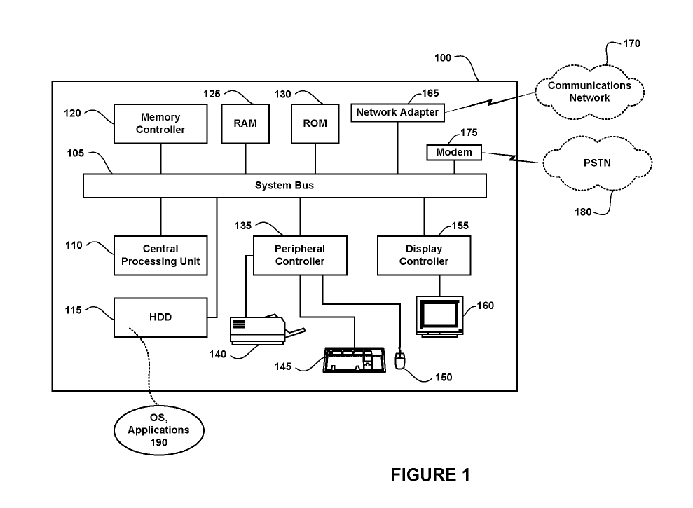

FIG. 1 depicts an exemplary computing system 100 that can be used in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, mobile devices, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output generated by computing system 100. Such visual output may include text, graphics, animated graphics, and/or video, for example. Display 160 may be implemented with a CRT-based video display, an LCD-based display, gas plasma-based display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet, and hence which may provide or include tracking of and access to the domain data discussed herein. Communications network 170 may provide user access to computing system 100 with means of communicating and transferring software and information electronically, and may be coupled directly to computing system 100, or indirectly to computing system 100, such as via PSTN or cellular network 180. For example, users may communicate with computing system 100 using communication means such as email, direct data connection, virtual private network (VPN), Skype or other online video conferencing services, or the like. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

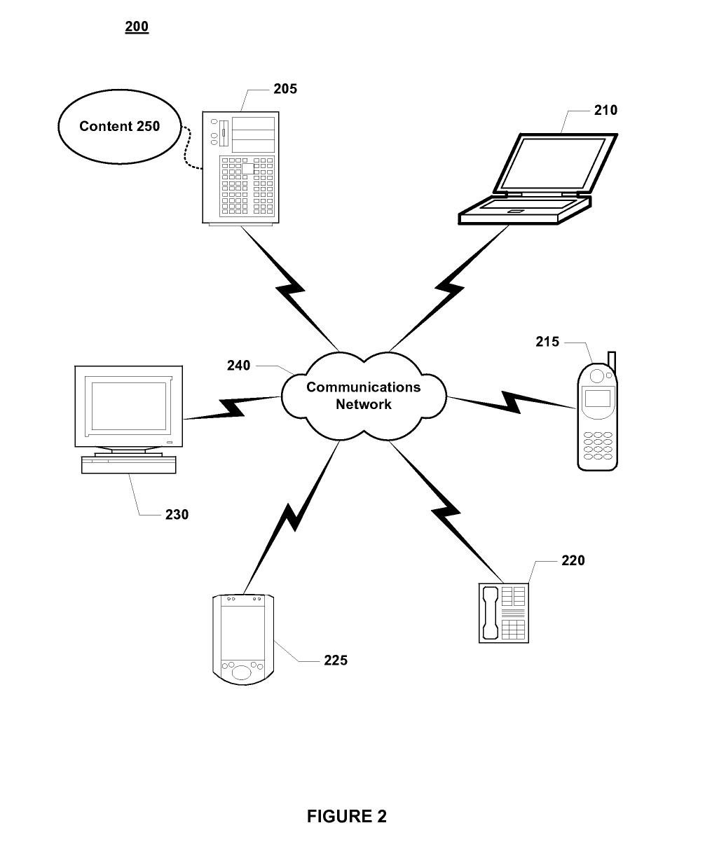

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or independently developed applications, the like, to interact with server 205.

The server 205 may thus deliver applications specifically designed for mobile client devices, such as, for example, client device 225. A client device 225 may be any mobile telephone, PDA, tablet or smart phone and may have any device compatible operating system. Such operating systems may include, for example, Symbian, RIM Blackberry OS, Android, Apple iOS, Windows Phone, Palm webOS, Maemo, bada, MeeGo, Brew OS, and Linux for smartphones and tablets. Although many mobile operating systems may be programmed in C++, some may be programmed in Java and .NET, for example. Some operating systems may or may not allow for the use of a proxy server and some may or may not have on-device encryption. Of course, because many of the aforementioned operating systems are proprietary, in prior art embodiments server 205 delivered to client device 225 only those applications and that content applicable to the operating system and platform communication relevant to that client device 225 type.

JavaScript Serialized Object Notation (JSON), a lightweight, text-based, language-independent data-interchange format, is based on a subset of the JavaScript Programming Language, Standard ECMA-262, 3.sup.rd Edition, dated December 1999. JSON syntax is a text format defined with a collection of name/value pairs and an ordered list of values. JSON is very useful for sending structured data over wire (e.g., the Internet) that is lightweight and easy to parse. It is language and platform independent, but uses conventions that are familiar to C-family programming conventions. The JSON language is thus compatible with a great many operating systems (a list of such systems is available at www.json.org).

The techniques described herein may be used for various wireless communication networks, such as CDMA, TDMA, FDMA, OFDMA, SC-FDMA, and other wireless networks. The terms “network” and “system” are often used interchangeably herein. By way of example, a CDMA network may implement a radio technology such as Universal Terrestrial Radio Access (UTRA), cdma2000, and the like. For example, an OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, and the like. UTRA and E-UTRA are part of Universal Mobile Telecommunication System (UMTS). UTRA, E-UTRA, UMTS, as well as long term evolution (LTE) and other cellular techniques, are described in documents from an organization named “3rd Generation Partnership Project” (3GPP) and “3rd Generation Partnership Project 2” (3GPP2).

“WiFi” stands for “Wireless Fidelity.” WiFi is typically deployed as a wireless local area network (WLAN) that may extend home and business networks to wireless medium. As referenced, the IEEE 802,11 standard defines WiFi communications as between devices, and as between devices and access points. WiFi typically provides aggregate user data speeds from 2 Mbps (for 802.11b) to approximately 150 Mbps (for 802.11n). Typical speeds for WiFi are around 15 Mbps, and latency (i.e., packet delay) averages around 10 ms with no load. WiFi may link devices, and/or devices and access points, over distances from a few feet to several miles. By way of contrast, LTE, as mentioned above, typically provides WAN connectivity that may stretch for much greater distances, but is typically not preferred for LAN communications. Of note, the techniques described herein may be used for the wireless networks and radio technologies mentioned above, as well as for other wireless networks and radio technologies.

WiFi networks, herein also referred to as IEEE 802.11 wireless networks, may operate in two modes: infrastructure mode and ad-hoc mode. In infrastructure mode, a device connects to an access point (AP) [[EITHER USE THIS ABBREVIATION CONSISTENTLY, OR TAKE THE FOREGOING ABBREVIATION OUT]] that serves as a hub for connecting wireless devices to the network infrastructure, including, for example, connecting wireless devices to Internet access. Infrastructure mode thus uses a client-server architecture to provide connectivity to the other wireless devices. In contrast to the client-server architecture of infrastructure mode, in ad-hoc mode wireless devices have direct connections to each other in a peer-to-peer architecture.

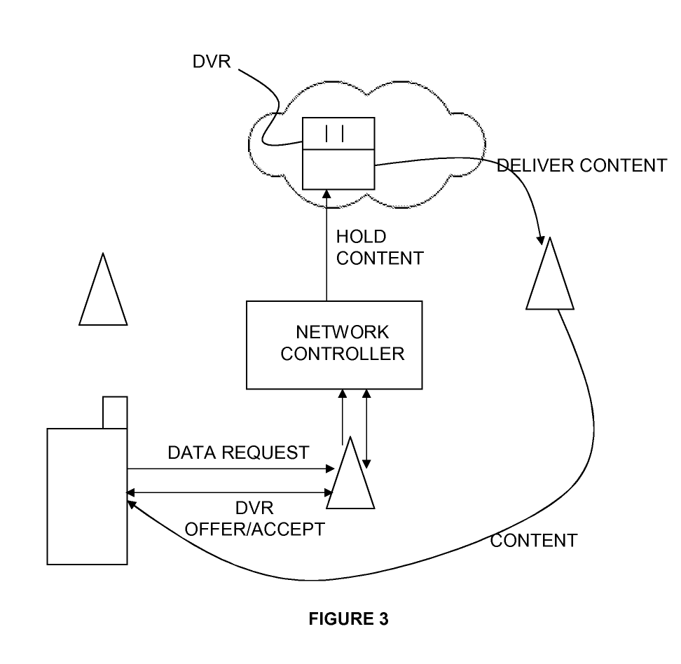

Referring now to FIG. 3, the present invention proposes to incentivize use of high volume users at less busy times across users. In short, the present invention allows for the chunking of the data, and the delivery of high bandwidth chunks to a requesting user at times that are more convenient for the network.

More particularly, if a user wishes to stream, for example, particular data-intensive content, i.e., such streaming will consist of high-volume dataflow, the user may be provided with options from the network manager (or network controller) to her device. In a first option, it may be offered to stream the data now as requested, in which case the user may pay for a usage overage. In a second option, the user may be enabled to direct the content to a personal mobile digital video recorder (DVR).

That is, the user may have a mobile DVR uniquely associated with that user, such that data entry into that DVR is secure and/or password protected, and content may be downloaded, streamed, or otherwise sent at a later time (i.e., not when requested) to the user's device. Thus, the content maybe downloaded, for example, to the user's device at 3 AM, i.e., at a time when network bandwidth constraints are not severe. If the user does not have an immediate need for the content, the user thus saves on data overage fees, and nevertheless obtains the desired content.

The mobile DVR may include storage in the cloud that is available to mobile devices, may include storage available at a base station for mobile devices, or may include storage available at regional servers, by way of non-limiting example. Of note, the present invention differs from Apple's icloud, and competitors' cloud storage locations, at least because, in the present invention, all storage, including the cloud storage, is fleeting. That is, storage only occurs until the next low usage point, or until a desired or selected low usage point, and then the requested data is downloaded to the requesting mobile at that low usage point.

Downloading may include streaming, general data transfer via a downlink, or the like, by way of non-limiting example. Downloading at the low usage time will prevent data use overage charges for high-volume users. The present invention may further monitor usage rates in real time, such that data requested they be directed to DVR in real-time as low use rates occur, and low usage points may be assessed to allow for download in real-time. More particularly, a user may be assured that, if she elects to wait for her data, she will receive it “No later than 2 am,” because the network manager knows that a low usage point is guaranteed to occur at 1:45 am. However, in such a case, if the network recognizes a low usage point at 9:30 pm, and the DVR queue is such that there is bandwidth available to download the requested content, the transfer may occur at 9:30 pm, rather than 1:45 am.

Those of skill in the art will appreciate that the herein described systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

What is claimed is:

1. A method of latent delivery of data-intensive content, comprising:
receiving, by a network manager having associated therewith at least one processor, a request for the data-intensive content from a mobile user;
providing, upon direction of the network manager, the mobile user with at least the options to:
receive the data-intensive content substantially simultaneously with the request correspondent to a usage charge; or
direct the content to mobile data computing storage uniquely associated with, and remote from a mobile device of, the mobile user, for receipt by the mobile user at a time substantially latent from the request; and
receiving from the mobile user of a selection of one of the options.

2. The method of claim 1, wherein the receipt by the user at the latent time is correspondent to a charge lower than the usage overage charge.

3. The method of claim 1, wherein the receipt by the user at the latent time is correspondent to no charge.

4. The method of claim 1, wherein the mobile data computing storage is secure.

5. The method of claim 1, wherein the mobile data computing storage is password protected.

6. The method of claim 1, further comprising delivering the data intensive content to the user.

7. The method of claim 6, wherein said delivering comprises downloading.

8. The method of claim 6, wherein said delivering comprises streaming.

9. The method of claim 6, wherein said delivering comprises sending.

10. The method of claim 9, wherein said sending comprises emailing.

11. The method of claim 1, wherein the mobile data computing storage resides in a cloud.

12. The method of claim 1, wherein the mobile data computing storage resides in a base station.

13. The method of claim 1, wherein the mobile data computing storage resides in a regional server.

14. The method of claim 13, wherein the regional server comprises an edge server.

15. The method of claim 1, wherein the substantially latent time comprises a time of day determined by the network manager.

16. The method of claim 1, wherein the substantially latent time comprises a time of day requested by the user.

17. The method of claim 1, wherein the substantially latent time comprises a low network usage time subsequent to the request.

18. The method of claim 17, wherein the low network usage time is determined in real time.

19. The method of claim 1, further comprising expiring the data-intensive content from the mobile data computing storage upon delivery of the data-intensive content to the mobile user.

20. The method of claim 1, wherein the latent option comprises a not later than time.
